(19) United States
(12) Patent Application Publication
(10) Pub. No.: US 2004/0177247 A1
(43) Pub. Date: Sep. 9, 2004

(54) Policy enforcement in dynamic networks

(76) Inventor: Amir Peles, Tel Aviv (IL)

Correspondence Address: KATTEN MUCHIN ZAVIS ROSENMAN, 575 MADISON AVENUE, NEW YORK, NY, 10022-2585, US

(21) Appl. No.: 10/713,677

(22) Filed: Nov. 14, 2003

Related U.S. Application Data
(60) Provisional application No. 60/452,136, filed on Mar. 5, 2003.

(51) Int. Cl. H04L 9/00

(52) U.S. Cl. 713/155

(57) ABSTRACT

When a user makes a request to a server for a specific service, a decision must be made as to whether the user's traffic should be forwarded to the server providing the requested service and where to forward the user's traffic. This decision may be made on the basis of the user's access privileges (i.e. whether the user is allowed to access the service), service level parameters (e.g. amount of network bandwidth the user is limited to or guaranteed to), or security services (i.e. activated anti-virus or URL filters). Every time a user makes an authentication request, a Service policy director collects the user's identification and service attribute information during authentication and registration phases. For each identified user, these attributes are stored in a User Policy Table. The Service policy director consults the User Policy Table to determine whether to forward the user's traffic. The Service policy director may also collect network traffic statistics or statistics pertaining to individual user traffic.

### BACKGROUND OF THE INVENTION

1. Field of Invention

The present invention relates generally to the field of service provisioning in a network. More specifically, the present invention is related to user service policy implementation and enforcement.

2. Discussion of Prior Art

Everyday, users connect to a network for the purpose of utilizing services that the network supplies. As the Internet grows and evolves, more and more users access networks and the services provided by these networks everyday. Such services are comprised of access privileges, which permit access to servers that provide different resources. Services are also comprised of security services, which protect the user from malicious attacks and malicious code that may be propagated on the network. Other services include quality services, which guarantee the user a specific amount of network bandwidth sufficient to satisfy the user's application requirements. Still other services may include activity summary services, which supply statistics about a user's activity. To allow a user to utilize these services, a subscription to the service may be required. A subscription might be required to appropriately charge users for the use of the service, and to keep other users who have not subscribed to the service from using it. Therefore, it is important to implement a policy to ensure subscribed users are able to access these services and users without a subscription are not able to access these services.

Service providers currently employ the use of a dynamic model to manage the users that connect to their networks. Whenever a user wishes to connect to a service provider, the user must first connect to an access server. An access server authenticates a user and allocates an Internet address for this user. The access server then enables the services that a user holding that Internet address is entitled to access. Since many services are available to the users of the network, the access server must provision the servers that provide these services (service-providing servers) with a correct service policy for a specific user and notify these servers of the user's newly allocated Internet address as well as the user's newly provisioned service parameters. When a user accesses the network, the user's traffic is redirected to the service-providing server. Each service-providing server consults a service policy for that user to verify the user's entitlement to the service, and then proceeds to provide service accordingly. In this manner, the user is able to benefit from all the services he or she has subscribed to or is entitled to use.

Prior art in the field of provisioning suggest three distinct implementations. The first implementation suggests pushing provisioning, which consists of steps including; the access server pushing a service policy belonging to a new user to user-requested service-providing servers. When the user connects to the requested service, the service-providing server uses that service policy in order to serve the user. This implementation requires a number of service policy configuration commands to flow through the network. When a certain service-providing server is operational, it needs to obtain the information of all the existing users to make sure the service is provided to the appropriate users. This process increases network overhead.

The second implementation suggests polling provisioning. The access server stores a user's service policy locally and does not distribute it to the service-providing servers. When a user requests a specific service, the service-providing server queries the access server about the user's service policy, and serves the user according to the response from the access server. While this implementation eliminates the need to configure the service with the service polices for all active users, it requires the service-providing server to query the access server every time a user attempts to access the service that the service-providing server provides. This can create excess network traffic and slow the services down.

Both of these implementations require communication between the access server and the service-providing servers. This creates a dependency between the two network devices, which limits the interoperability of network equipment in general and also limits the deployment of intelligent network services.

The third implementation solely involves the access server. After authenticating a user, the access server may also take part in forwarding traffic from the user. Next, it will forward the traffic to relevant service-providing servers according to the user's service policy. This operation requires an increased amount of resources from the access server, and does not scale with large numbers of users or higher network bandwidth.

Whatever the precise merits, features and advantages of the above cited art, none of them achieve or fulfills the purposes of the present invention. Therefore, a system and method that allows service provisioning and enforcement of service policies independently of an access server is sought.

### SUMMARY OF THE INVENTION

The present invention provides a new method of service provisioning. A network device called a Service Policy Director is introduced. This network device resides on a network and receives traffic flowing between a user and a service-providing server either by allowing traffic to pass through it or by receiving a copy of the traffic from some other network device (e.g., a network switch). When a user first connects, a Service Policy Director monitors authentication, authorization and registration phases to discover the user's information, which includes the user's Internet address and services that the user is authorized to use. Then, whenever the user tries to access services by connecting to the service provider's network, the Service Policy Director manages a user request by intercepting and forwarding user traffic to services that the user is authorized to use—services that the user has subscribed to or is entitled to use. Each service-providing server will only receive traffic that it should receive according to a user's service policy. Service-providing servers are not required to hold users' service policy information, or query an access server when a new user connects to the network. In one embodiment, a Service Policy Director also offers services internal to the network such as bandwidth management, access control (e.g., blocking conditional traffic by the Service Policy Director), and network usage statistics logging.

### BRIEF DESCRIPTION OF THE DRAWINGS

FIG. 1(a) illustrates the Service Policy Director operating in transparent mode;

FIG. 1(b) illustrates the Service Policy Director operating in proxy mode;

FIG. 1(c) illustrates the Service Policy Director operating in passive mode;

FIG. 2 illustrates the Service Policy Director populating the User Policy Table;

FIG. 3 illustrates the application of a user's service policy bandwidth restriction/limitation on the user's traffic;

FIG. 4 illustrates the application of a user's service policy access privileges on the user's traffic;

FIG. 5 illustrates the application of a user's service policy security services on the user's traffic;

FIG. 6(a) illustrates the Service Policy Director obtaining traffic statistics in transparent mode;

FIG. 6(b) illustrates the Service Policy Director obtaining traffic statistics in passive mode.

### DESCRIPTION OF THE PREFERRED EMBODIMENTS

While this invention is illustrated and described in a preferred embodiment, the device may be produced in many different configurations, forms and materials. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

When a user initiates a connection with a service provider's network, a sequence of messages are sent from a user request-issuing device or from a remote access server of that user to an authentication server. These messages are sent via authentication and authorization protocols such as RADIUS, LDAP, NFS and others. During an authentication phase, through messages transmitted in accordance with a chosen protocol, a user identifies himself or herself to an authentication server. The authentication server authenticates and authorizes the user automatically or by a password. After the authentication phase, the user is supplied with an Internet address and service attributes that define or limit the user's behavior on a network. These limitations include limitations on services a user is allowed to access, the type of traffic a user is allowed to send, or the amount of traffic a user is allowed to send. Such service attributes relate to services that a user has subscribed to or is entitled to use. Examples of service attributes are security services entitlement parameters, access privileges parameters, traffic logging mechanisms and user activity statistics entitlement parameters, or service quality level parameters. However, other known or future attributes, or their equivalents may be substituted therefore without departing from the scope of the present invention.

A Service Policy Director monitors messages transmitted over a network to obtain information about a user and service attributes associated with that user. Each user identifier and set of service attributes associated with that user is then stored in a User Policy Table residing on a Service Policy Director network device.

To allow a Service Policy Director to monitor messages transmitted over a network, the Service Policy Director must receive the authentication traffic of a user.

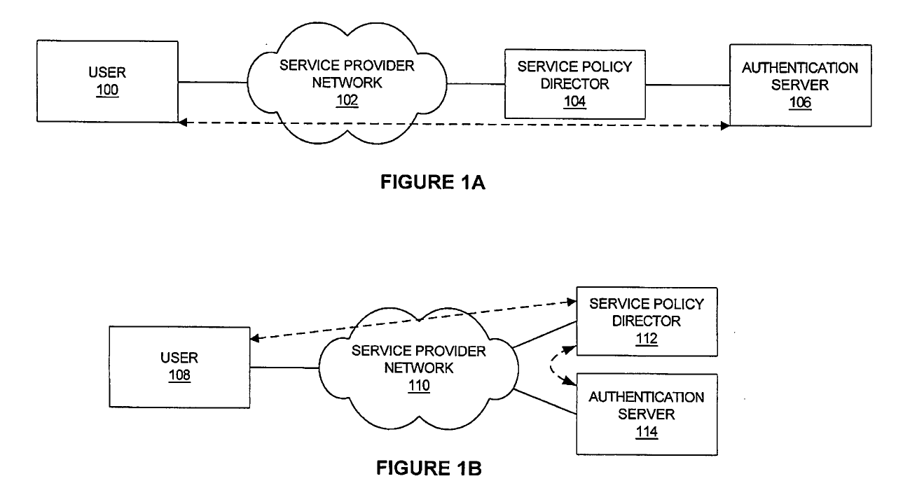

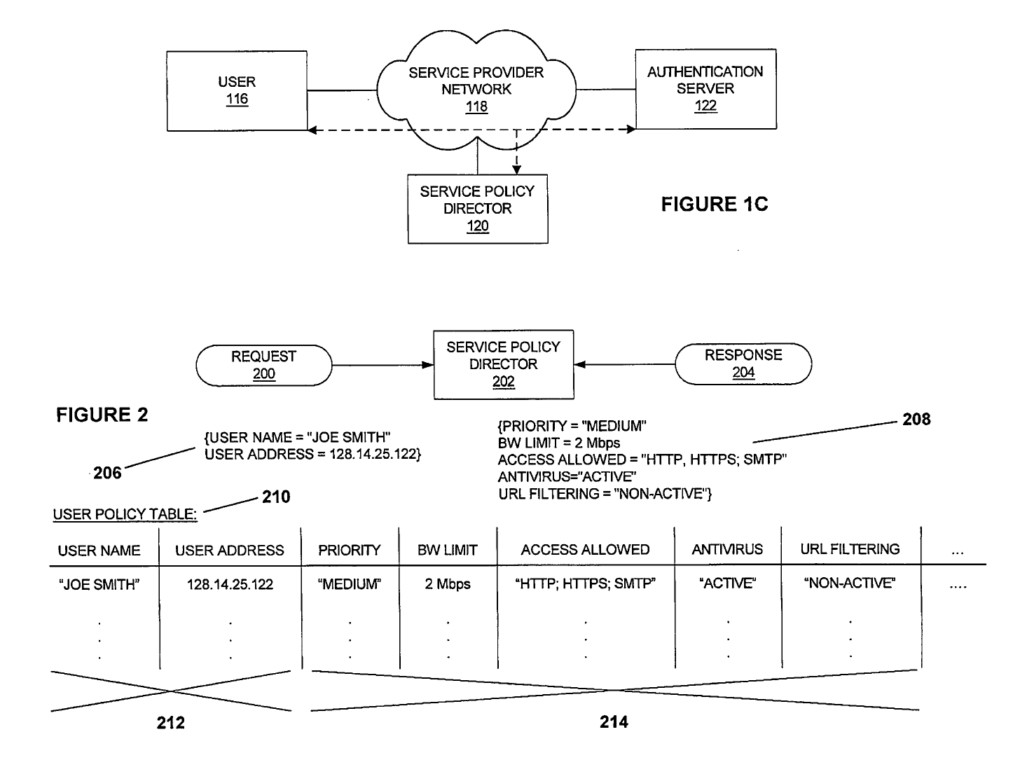

In one embodiment, a Service Policy Director is transparent by being placed on a path of network traffic, between users and an access server to the authentication server. FIG. 1(a) illustrates message monitoring by a Service Policy Director 104 as described in the first embodiment. In this first embodiment, a Service Policy Director 104 functions as a transparent switch. A Service Policy Director 104 is placed on a path between a user 100 and an authentication server 106, and receives and forwards messages sent by a user 100 destined for an authentication server 106. The Service Policy Director 104 receives and parses a response message sent by the authentication server, to obtain the identification and service attribute information of the user and then forwards these messages without making any changes to their contents.

In another embodiment, a Service Policy Director is configured as a proxy, such that all user authentication requests are sent to the Service Policy Director, rather than to an authentication server. The Service Policy Director will then query an authentication server for each of the user's identification and attribute information, and finally forward the response from the authentication server to the appropriate user. In FIG. 1(b), a user 108 sends messages directly to a Service Policy Director 112. The Service Policy Director 112 then redirects the user's messages to an authentication server 114. When the access server 114 responds, the Service Policy Director receives and parses a response message sent by the authentication server, to obtain the identification and service attribute information of the user and then forwards the response directly to the user 108.

In yet another embodiment, a user's authentication messages are copied by an additional network device (e.g., a switch), and passed to a passively listening Service Policy Director. In FIG. 1(c), network traffic is copied to a Service Policy Director 120 while traffic is in transit over a network. The Service Policy Director 120 monitors copied traffic for user authentication requests and authentication server responses. Finally, the Service Policy Director parses copied message traffic to obtain identification and service attribute information of users 116 on the network. In each embodiment, a Service Policy Director monitors authentication message communication and stores user's identity and service attributes associated with each user in its internal User Policy Table 210.

In FIG. 2, a Service Policy Director 202 obtains user information by parsing both user authentication requests 200 and authentication server responses 204 in order to obtain user identifiers 206 and service attributes 208. Examples of user identifiers are user name, Internet address, session ID, or cookie value. Examples of service attributes are a user priority, a user limit of bandwidth, user bandwidth guarantee, a list of allowed or denied user traffic, user entitlement to security services like AntiVirus and URL filtering, or user entitlement for statistics gathering. However, other known or future user identifiers and service attributes, or their equivalents may be substituted therein without departing from the scope of the present invention.

This information is inserted into a User Policy Table 210 and stored in a Service Policy Director 202 network device memory for the duration of a transaction. Each time a user initiates a connection to a service provider's network and requests access from an access server—for example, by providing a login name and password, the User Policy Table 210 is updated. The User Policy Table 210 provides a correlation between the identifiers of a user 206 and service attributes for this user. Identification information such as session ID and specific protocol identifier (e.g., cookie), are used to provide a correspondence from a user to attributes defining or limiting services for the user after a first access request. Different identification information such as Internet address or name is used to provide the initial correspondence between a user and attributes defining or limiting services for the user. The user information is kept in the User Policy Table 210 unit the Service Policy Director 202 receives a disconnection message from the user 206 or until a new user sends an authentication request with the same user information. In the latter case, the user information is modified with the identifiers and service attributes of the new user.

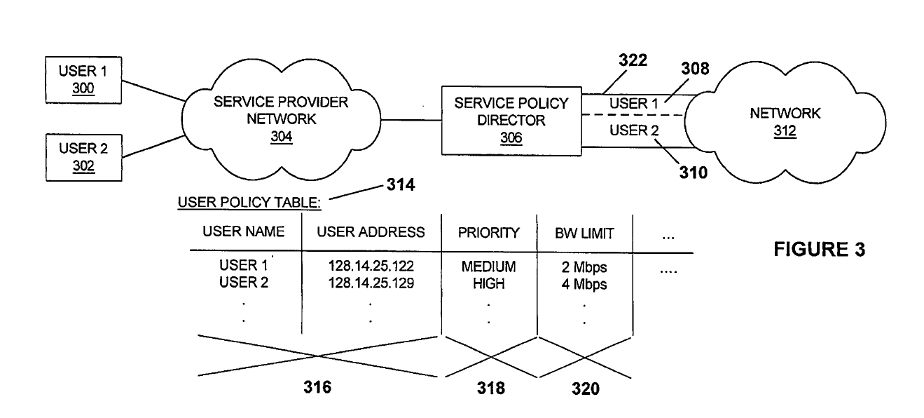

After the authentication phase users send traffic destined for a service-providing server. A Service Policy Director is situated on a path between users and the service-providing server these users are trying to access. In FIG. 3, a bandwidth policy is applied to user traffic—when data traffic arrives from a user 1 300 (for example, traffic directed to a web server), Service Policy Director 306 matches packet data with a user identifier 316 from User Policy Table 314 to determine the user's identity. If an entry for the user 1 300 is found in User Policy Table 314, Service Policy Director 306 applies bandwidth priority 318, bandwidth limitation 320, and a bandwidth guarantee as specified in the user's service policy, to traffic sent by this user 1 300. In FIG. 3, User 1 300 has a bandwidth limit 320 of two Mbps whereas User 2 302 has a bandwidth limit 320 of four Mbps.

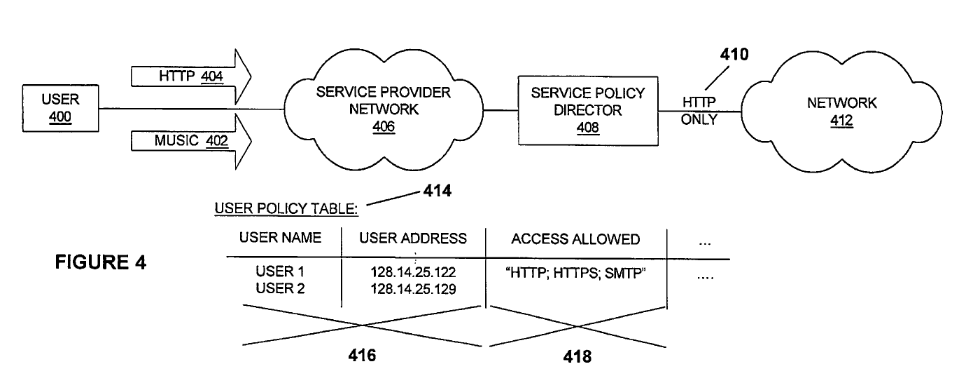

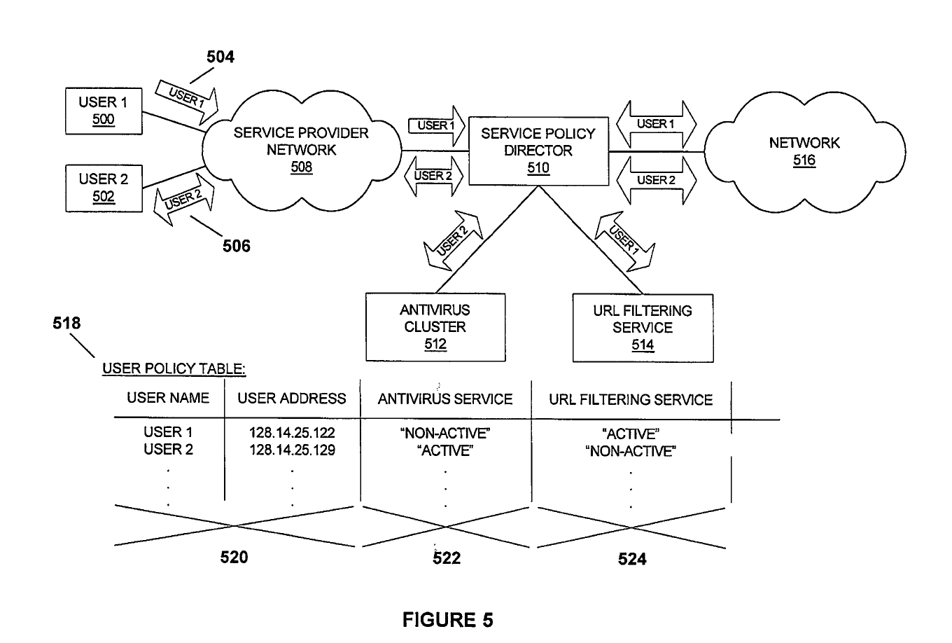

In FIG. 4, another example of applying access control according to filtering attributes 418 defined in the user's service policy is shown. When traffic destined for a service-providing server 412 arrives at a Service Policy Director 408, the Service Policy Director 408 determines the user's identity 416 and applies access-filtering rules 418 to traffic sent by this user 400. HTTP traffic 404 coming from the user 400 is allowed, so the Service Policy Director 408 forwards HTTP traffic 410 to the service-providing server 412. Music traffic 402 coming from the user 400 is not in the allowed list 418 so the Service Policy Director 408 blocks this traffic. Attributes of access control may include the user's IP address, a TCP/UDP port number, and any content pattern in a user's traffic.

FIG. 5 illustrates an example of applying security services to user traffic—after a Service Policy Director 510 identifies User 1, it redirects User l's traffic 504 through security services, in this case URL filtering security software 514. In the case of User 2, the Service Policy Director 510 redirects user 2's traffic through anti-virus security software 512 in accordance with the user's service policy 522 found in a User Policy Table 518.

Thus, a Service Policy Director provides a network device to serve user traffic with a specified priority, a specified limit or guarantee for bandwidth, and to inspect user traffic for security breaches, as well as log and redirect user traffic along a path that maintains a requisite level of security. Service level parameter attributes further define services including any of the following (not limited to): classification of traffic, modification of traffic, updating of traffic statistics, or forwarding of traffic according to a user's service policy. In an alternate embodiment, a Service Policy Director offers network services such as, but not limited to: bandwidth management, access control, or network usage statistics logging.

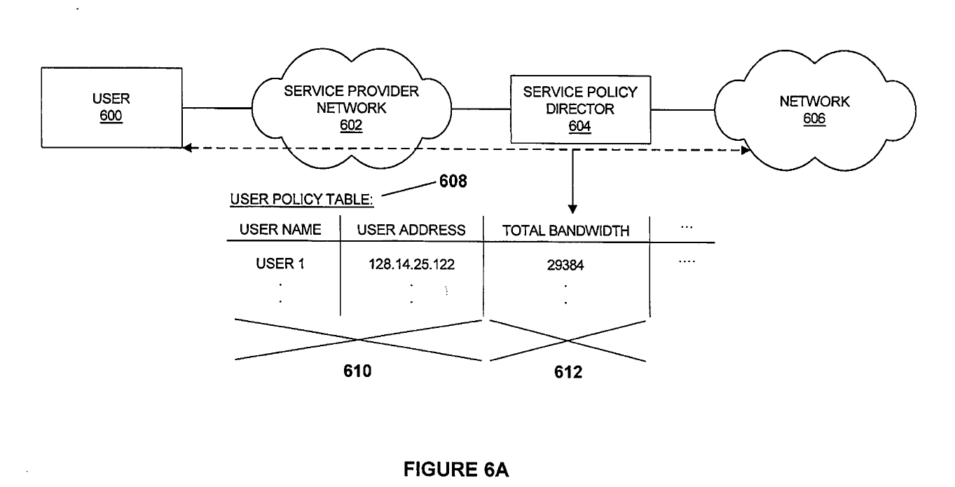

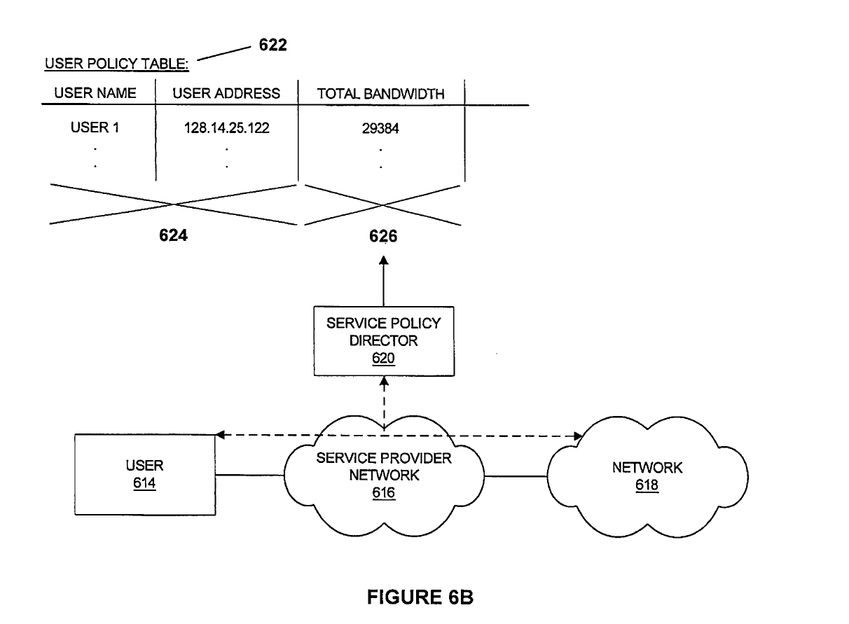

Since network traffic flows through various servers around a Service Policy Director, a Service Policy Director can also be used for monitoring services and redirecting traffic to servers that that are better able to handle a high volume of requests, or to a server that meets any of a plurality of criteria. The present invention allows having more than a single server for every service, and thus offers opportunities for load balancing. In FIG. 6(a) and 6(b) examples of gathering statistics of user traffic are shown. When data traffic arrives from a user 600, a Service Policy Director 604 matches traffic with a user's identifier 610 to determine the user's identity. If the user is located in User Policy Table 608, Service Policy Director 604 records statistics of the user's activity and can later report it or present it to an operator (e.g., of an enterprise, a local carrier, or a service provider's network). This kind of service is available in two modes—as shown in FIG. 6(a) when a Service Policy Director 604 is situated in a path of traffic, or as shown in FIG. 6(b) when a Service Policy Director 620 receives a copy of network traffic.

### CONCLUSION

A system and method has been shown in the above embodiments for the effective implementation of policy enforcement in dynamic networks. While various preferred embodiments have been shown and described, it will be understood that there is no intent to limit the invention by such disclosure, but rather, it is intended to cover all modifications and alternate constructions falling within the spirit and scope of the invention, as defined in the appended claims. For example, the present invention should not be limited by software/program, computing environment, and specific computing hardware, and specific numbers of users, servers, types of Internet services offered, access protocols, transmission protocols, and amount of bandwidth. In addition, while individual modes (configurations) have been shown in FIGS. 1(a) through 1(c), variations using multiple Service Policy Directors in various combinations of these modes are within the scope of the present invention.

The above enhancements are implemented in various computing environments. For example, the present invention may be implemented on a conventional multi-nodal system (e.g. LAN) or networking system (e.g. Internet, intranet, WWW, wireless web). The programming of the present invention may be implemented by one of skill in the art of network programming.

1. A method for enforcing service policies over a network, said method implemented in a network device, comprising the steps of:
a. receiving authentication messages for a user at said network device;
b. determining user identifiers and service attributes associated with said user;
c. creating a user service policy entry in a user policy table for said identified user containing said service attributes;
d. consulting said user policy table to determine how to manage said user traffic subsequent to said user authentication messages; and
e. managing subsequent user traffic based on said consulting step.

2. A method for enforcing service policies over a network, as per claim 1, wherein said determining step includes monitoring and parsing said user authentication messages to obtain said user identity and attributes associated with said user.

3. A method for enforcing service policies over a network, as per claim 1, wherein said user policy table is located within said network device.

4. A method for enforcing service policies over a network, as per claim 1, wherein said network device offers internal network services comprising at least one of bandwidth management, access control or network usage statistics.

5. A method for enforcing service policies over a network, as per claim 1, wherein said authentication messages are using any of the Radius protocol or the LDAP protocol.

6. A method for enforcing service policies over a network, as per claim 1, wherein said network device functions in any one of, or a combination of, the following modes:
a. transparent mode, wherein the authentication messages in a provider network pass through the network device without any modification to the IP addresses and data of said authentication messages;
b. proxy mode, wherein the authentication messages in a provider network pass through the network device, said network device modifies IP addresses of said authentication messages without any modification to the data of said authentication messages; and
c. passive mode, wherein the authentication messages in a provider network are copied to the network device.

7. A method for managing network user traffic received by a network device, said network user traffic including at least a request for a server or service, said method comprising steps of:
a. identifying a user originating said network user traffic;
b. consulting a user policy table to locate a user service policy corresponding to said user; and
c. managing said network user traffic based on said consulting step by any one or more of the following:
i. forwarding network user traffic to a requested server,
ii. redirecting network user traffic to a server providing a same service as a requested server,
iii. sending network user traffic through filtering software before forwarding user traffic to a requested server,
iv. denying transmission of user traffic on the basis of access privileges,
v. counting or logging user traffic in order to provide network usage information, or
vi. denying or delaying transmission of network user traffic on the basis of service level parameters.

8. A method for managing network user traffic received by a network device, as per claim 7, wherein said user policy table is filled according to information in user authentication messages.

9. A method for managing network user traffic received by a network device, as per claim 8, wherein authentication messages are using any of the Radius protocol or the LDAP protocol.

10. A method for managing network user traffic received by a network device, as per claim 7, wherein said network device offers internal network services comprising at least one of bandwidth management, access control or network usage statistics.

11. A method for managing network user traffic received by a network device, as per claim 7, wherein said network device functions in any one of the following modes:
a. transparent mode, wherein the authentication messages in a provider network pass through the network device without any modification to the IP addresses and data of said authentication messages;
b. proxy mode, wherein the authentication messages in a provider network pass through the network device, said network device modifies IP addresses of said authentication messages without any modification to the data of said authentication messages; and
c. passive mode, wherein the authentication messages in a provider network are copied to the network device.

12. A method for enforcing service policies over a network, said method implemented in a network device comprising steps of:
a. receiving authentication messages for a user at said network device;
b. determining user identifiers and service attributes associated with said user;
c. creating a user service policy entry in a user policy table for said identified user based on said service attributes;
d. consulting said user policy table to determine how to manage user traffic subsequent to said user authentication message; and
e. managing said subsequent user traffic including any one or more of the following:
i. forwarding user traffic to requested server,
ii. redirecting user traffic to a server providing same service as requested server,
iii. sending user traffic through filtering software before forwarding user traffic to requested server,
iv. denying transmission of user traffic on the basis of access privileges,
v. counting or logging user traffic in order to provide network usage information or
vi. denying or delaying transmission of user traffic on the basis of service level parameters.

13. A method for enforcing service policies over a network, as per claim 12, wherein authentication messages are using any of the Radius protocol or the LDAP protocol.

14. A method for enforcing service policies over a network, as per claim 12, wherein said network device offers internal network services comprising at least one of bandwidth management, access control or network usage statistics.

15. A method for enforcing service policies over a network, as per claim 12, wherein said network device functions in any one of the following modes:
a. transparent mode, wherein the authentication messages in a provider network pass through the network device without any modification to the IP addresses and data of said authentication messages;
b. proxy mode, wherein the authentication messages in a provider network pass through the network device, said network device modifies IP addresses of said authentication messages without any modification to the data of said authentication messages; and
c. passive mode, wherein the authentication messages in a provider network are copied to the network device.

16. A system for enforcing service policies over a network comprising the following:
a user request-issuing device;
a service provider network over which user authentication messages and user traffic originated by said user request-issuing device is transmitted;
an authentication server to which said user request-issuing device attempts to connect and by which said user request-issuing device is authenticated and registered; and
a service policy director independent of said authentication server, enforcing a service policy for said user request-issuing device,
wherein said user request-issuing device may be included in at least a network access server of a service provider network or in a user network.

17. A system for enforcing service policies over a network, as per claim 16, wherein said service policy director includes a user policy table.

18. A system for enforcing service policies over a network, as per claim 17, wherein said user policy table includes user identifier information and service attribute information.

19. A system for enforcing service policies over a network, as per claim 18, wherein said user identifier information includes at least an Internet/intranet address.

20. A system for enforcing service policies over a network, as per claim 19, wherein said user identification information further includes any of username, session identification or Internet cookie.

21. A system for enforcing service policies over a network, as per claim 18, wherein said attribute information includes any one or more of the following: access privileges parameters, traffic logging mechanisms and user activity statistics entitlement parameters, security services entitlement parameters, or service quality level parameters.

22. A system for enforcing service policies over a network, as per claim 21, wherein said service quality level parameters include any one or more of the following: a bandwidth limit, a bandwidth guarantee, or a bandwidth priority.

23. A system for enforcing service policies over a network, as per claim 25, wherein said service attributes define services offered by said service policy director, said services including any one or more of the following: classification of network user traffic, modification of network user traffic, forwarding of network user traffic, or logging of single network user traffic statistics.

24. A system for enforcing service policies over a network, as per claim 16, wherein said network device offers internal network services including at least one of bandwidth management, access control or network usage statistics.

25. A system for enforcing service policies over a network, as per claim 18, wherein a plurality of said service policy directors reside on a network.

26. A system for enforcing service policies over a network, as per claim 16, wherein said network device including said service policy director functioning in a transparent mode, wherein the authentication messages in a provider network pass through the network device without any modification to the IP addresses and data of said authentication messages.

27. A system for enforcing service policies over a network, as per claim 26, wherein said service policy director functioning in said transparent mode receives said user authentication request messages addressed to said authentication server and forwards said user authentication request messages to said authentication server.

28. A system for enforcing service policies over a network, as per claim 16, wherein said network device including said service policy director functioning in a proxy mode, wherein the authentication messages in a provider network pass through the network device, said network device modifies IP addresses of said authentication messages without any modification to the data of said authentication messages.

29. A system for enforcing service policies over a network, as per claim 28, wherein said service policy director functioning in said proxy mode receives said user authentication request messages addressed to said service policy director and forwards it to said authentication server.

30. A system for enforcing service policies over a network, as per claim 16, wherein said network device comprising said service policy director functioning in a passive mode, wherein the authentication messages in a provider network are copied to the network device.

31. A system for enforcing service policies over a network receiving user access request traffic, said system comprising a service policy director in any of the following configurations:
a user request-issuing device operatively connected a service policy director, said service policy director connected to an authentication server, and said authentication server being operatively connected to said user request-issuing device, wherein said service policy director receives said user authentication request messages addressed to said authentication server and forwards said user authentication request messages to said authentication server;
a user request-issuing device operatively connected a service policy director, said service policy director being operatively connected to said user request-issuing device, and an authentication server being operatively connected to said service policy director, wherein said service policy director, receives said user authentication request messages and queries said authentication server; and
a user request-issuing device operatively connected to a service policy director, said service policy director receiving copied network user traffic, said copied network user traffic copied by a network device, and said user-request issuing device being operatively connected to said service policy director, the service policy director receives a copy of said user authentication request messages addressed to and destined for said authentication server.
